(19) United States
(12) Patent Application Publication
(10) Pub. No.: US 2025/0237938 A1
(43) Pub. Date: Jul. 24, 2025

(54) PHOSPHOR WHEEL, LIGHT SOURCE DEVICE, AND PROJECTION IMAGE DISPLAY DEVICE

(71) Applicant: Panasonic Holdings Corporation, Osaka (JP)

(72) Inventors: Takashi IKEDA, Osaka (JP); Yusaku NISHIKAWA, Osaka (JP)

(21) Appl. No.: 19/176,381

(22) Filed: Apr. 11, 2025

Related U.S. Application Data
(63) Continuation of application No. PCT/JP2023/035254, filed on Sep. 27, 2023.

(30) Foreign Application Priority Data
Oct. 13, 2022 (JP) 2022-164740

(51) Int. Cl. G03B 21/20; G02B 26/00

(52) U.S. Cl. CPC G03B 21/204; G02B 26/008

(57) ABSTRACT

A phosphor wheel includes: a rotatable base plate; a plurality of wavelength conversion layers arranged on the base plate, and including a first and a second sintered body type wavelength conversion layer which are arranged adjoining each other in a circumferential direction around a center of rotation of the base plate, the first having a sintered body of first wavelength conversion particles that wavelength-convert excitation light into a first wavelength, the second having a sintered body of second wavelength conversion particles that wavelength-convert the excitation light into a second wavelength different from the first wavelength; and an adhesive layer between the base plate and the plurality of wavelength conversion layers, wherein at a boundary where the first and second layers adjoin each other, the first layer having at its end in the circumferential direction a site not in contact with an end of the second layer in the circumferential direction.

### CROSS REFERENCE TO RELATED APPLICATION

This application claims priorities of Japanese Patent Application No. 2022-164740 filed on Oct. 13, 2022 and PCT Application No. PCT/JP2023/035254 filed on Sep. 27, 2023, the contents of which are incorporated herein by reference.

### BACKGROUND

### 1. Technical Field

The present disclosure relates to a phosphor wheel for use in a light source device of a projection type video display device, for example, a light source device, and a projection type video display device.

### 2. Description of the Related Art

A conventional phosphor wheel using a fluorescent layer (wavelength conversion layer) has been manufactured by a method using only a so-called mixed layer type wavelength conversion layer formed by applying phosphor particles dispersed in a resin paste or a method using only a sintered body type wavelength conversion layer made of sintered phosphor particles (see, e.g. WO2018/042949 A1).

### SUMMARY

The former phosphor wheel using the mixed layer type wavelength conversion layer has many selectable wavelengths and is cost-effective, but has issues with conversion efficiency and heat resistance. On the other hand, the phosphor wheel using the sintered body type wavelength conversion layer is superior in conversion efficiency and heat resistance, but has an issue with cost.

In addition, in the case where a plurality of sintered body type wavelength conversion layers are used adjoining each other, when attaching the sintered body type wavelength conversion layers to the base plate, pins for alignment between the wavelength conversion layers adjoining each other cannot be placed, rendering the alignment difficult.

The present disclosure is intended to solve the above-mentioned conventional problems, and one non-limiting and exemplary embodiments provides a phosphor wheel enabling alignment between first and second sintered body type wavelength conversion layers adjoining each other and having excellent conversion efficiency and heat resistance.

In one general aspect, the techniques disclosed here feature: a phosphor wheel includes:
a rotatable base plate;
a plurality of wavelength conversion layers arranged on the base plate, the plurality of wavelength conversion layers including a first sintered body type wavelength conversion layer and a second sintered body type wavelength conversion layer which are arranged adjoining each other in a circumferential direction around a center of rotation of the base plate, the first sintered body type wavelength conversion layer having a sintered body of first wavelength conversion particles that wavelength-convert excitation light into light with a first wavelength, the second sintered body type wavelength conversion layer having a sintered body of second wavelength conversion particles that wavelength-convert the excitation light into light with a second wavelength different from the first wavelength; and
an adhesive layer disposed between the base plate and the plurality of wavelength conversion layers,
wherein at a boundary where the first sintered body type wavelength conversion layer and the second sintered body type wavelength conversion layer adjoin each other, the first sintered body type wavelength conversion layer has at its end in the circumferential direction a site not in contact with an end of the second sintered body type wavelength conversion layer in the circumferential direction.

In another general aspect, the techniques disclosed here feature: a method for manufacturing a phosphor wheel includes:
applying an adhesive layer onto a base plate;
arranging a first sintered body type wavelength conversion layer and a second sintered body type wavelength conversion layer adjoining each other on the base plate, the first sintered body type wavelength conversion layer having a sintered body of first wavelength conversion particles that wavelength-convert excitation light into light with a first wavelength, the second sintered body type wavelength conversion layer having a sintered body of second wavelength conversion particles that wavelength-convert the excitation light into light with a second wavelength different from the first wavelength; and
curing the adhesive layer to securely attach the first sintered body type wavelength conversion layer and the second sintered body type wavelength conversion layer to the base plate,
wherein the step of arranging the first sintered body type wavelength conversion layer and the second sintered body type wavelength conversion layer includes arranging the first sintered body type wavelength conversion layer and the second sintered body type wavelength conversion layer so as to allow the first sintered body type wavelength conversion layer to have at its circumferential end a site not in contact with a circumferential end of the second sintered body type wavelength conversion layer at a boundary where the first sintered body type wavelength conversion layer and the second sintered body type wavelength conversion layer adjoin each other.

The phosphor wheel according to the present disclosure has the first and second sintered body type wavelength conversion layers that adjoin each other. As a result, excellent conversion efficiency and heat resistance can be obtained.

Additional benefits and advantages of the disclosed embodiments will be apparent from the specification and figures. The benefits and/or advantages may be individually provided by the various embodiments and features of the specification and drawings disclosure, and need not all be provided in order to obtain one or more of the same.

### BRIEF DESCRIPTION OF THE DRAWINGS

The present disclosure will become readily understood from the following description of non-limiting and exemplary embodiments thereof made with reference to the accompanying drawings, in which like parts are designated by like reference numeral and in which:

FIG. 1 is a schematic plan view showing a planar configuration of a phosphor wheel according to a first embodiment;

FIG. 2 is a flowchart showing steps of a method for manufacturing the phosphor wheel according to the first embodiment;

FIG. 3 shows, in the flowchart of the method for manufacturing a phosphor wheel of FIG. 2: (a) a planar see-through view showing a base plate having an adhesive layer disposed thereon and seen from the back surface of the base plate; (b) a front view showing the state where first sintered body type wavelength conversion layers are aligned on an attachment base in order to attach them onto the base plate of (a); (c) a front view showing the state where second sintered body type wavelength conversion layers are aligned adjoining the first sintered body type wavelength conversion layers; and (d) a schematic plan view showing the first and second sintered body type wavelength conversion layers aligned on the attachment base of (c) and arranged adjoining each other;

FIG. 4 is a schematic plan view showing a planar configuration of a phosphor wheel according to a second embodiment;

FIG. 5 is a schematic plan view showing a planar configuration of a phosphor wheel according to a third embodiment;

FIG. 6 is a schematic plan view showing first and second sintered body type wavelength conversion layers aligned on the attachment base and arranged adjoining each other in a method for manufacturing a phosphor wheel according to the third embodiment;

FIG. 7 is a schematic plan view showing a planar configuration of a phosphor wheel according to a fourth embodiment;

FIG. 8 is a view showing a configuration of a light source device according to a fifth embodiment;

FIG. 9 is a view showing a configuration of a projection type video display device mounted with the light source device according to the fifth embodiment;

FIG. 10 is a view showing a configuration of a light source device according to a sixth embodiment; and

FIG. 11 is a view showing a configuration of a projection type video display device mounted with the light source device according to the sixth embodiment.

### DETAILED DESCRIPTION

A phosphor wheel according to a first aspect, includes:
a rotatable base plate;
a plurality of wavelength conversion layers arranged on the base plate, the plurality of wavelength conversion layers including a first sintered body type wavelength conversion layer and a second sintered body type wavelength conversion layer which are arranged adjoining each other in a circumferential direction around a center of rotation of the base plate, the first sintered body type wavelength conversion layer having a sintered body of first wavelength conversion particles that wavelength-convert excitation light into light with a first wavelength, the second sintered body type wavelength conversion layer having a sintered body of second wavelength conversion particles that wavelength-convert the excitation light into light with a second wavelength different from the first wavelength; and
an adhesive layer disposed between the base plate and the plurality of wavelength conversion layers,
at a boundary where the first sintered body type wavelength conversion layer and the second sintered body type wavelength conversion layer adjoin each other, the first sintered body type wavelength conversion layer having at its end in the circumferential direction a site not in contact with an end of the second sintered body type wavelength conversion layer in the circumferential direction.

In the phosphor wheel according to a second aspect in addition to the first aspect, the site not in contact may be a notch disposed at the end of the first sintered body type wavelength conversion layer.

In the phosphor wheel according to a third aspect in addition to the first or second aspect, the site not in contact may be a cutout disposed on at least one of inner peripheral side and outer peripheral side at the end of the first sintered body type wavelength conversion layer.

In the phosphor wheel according to a fourth aspect in addition to any one of the first to third aspects, the first sintered body type wavelength conversion layer and the second sintered body type wavelength conversion layer may have at their adjoining boundary mutually different inner radii and/or mutually different outer radii from the center of rotation of the base plate.

In the phosphor wheel according to a fifth aspect in addition to any one of the first to fourth aspects, the first sintered body type wavelength conversion layer and the second sintered body type wavelength conversion layer may have at their adjoining boundary mutually different radial width around the center of rotation of the base plate.

In the phosphor wheel according to a sixth aspect in addition to any one of the first to fifth aspects, an end surface at the end of the first sintered body type wavelength conversion layer facing the second sintered body type wavelength conversion layer may extend toward inner peripheral side from a site in contact on the inner peripheral side with an end surface at the end of the second sintered body type wavelength conversion layer facing the first sintered body type wavelength conversion layer, and wherein
an end surface at the end of the second sintered body type wavelength conversion layer may extend toward outer peripheral side from a site in contact on the outer peripheral side with the end surface at the end of the first sintered body type wavelength conversion layer.

In the phosphor wheel according to a seventh aspect in addition to any one of the first to sixth aspects, the adhesive layer may be exposed between the site not in contact of the first sintered body type wavelength conversion layer and the end of the second sintered body type wavelength conversion layer.

In the phosphor wheel according to an eighth aspect in addition to any one of the first to seventh aspects, the phosphor wheel may have an opening disposed on a circumference on which the plurality of wavelength conversion layers are arranged around the center of rotation of the base plate.

In the phosphor wheel according to a ninth aspect in addition to any one of the first to eighth aspects, the phosphor wheel may have a reflective area disposed on a circumference on which the plurality of wavelength conversion layers are arranged around the center of rotation of the base plate.

A light source device according to a tenth aspect, includes the phosphor wheel according to any one of the first to ninth aspects.

A projection type video display device according to an eleventh aspect, includes the light source device according to the tenth aspect.

A method for manufacturing a phosphor wheel according to twelfth aspect, includes:
applying an adhesive layer onto a base plate;
arranging a first sintered body type wavelength conversion layer and a second sintered body type wavelength conversion layer adjoining each other on the base plate, the first sintered body type wavelength conversion layer having a sintered body of first wavelength conversion particles that wavelength-convert excitation light into light with a first wavelength, the second sintered body type wavelength conversion layer having a sintered body of second wavelength conversion particles that wavelength-convert the excitation light into light with a second wavelength different from the first wavelength; and
curing the adhesive layer to securely attach the first sintered body type wavelength conversion layer and the second sintered body type wavelength conversion layer to the base plate, wherein
the step of arranging the first sintered body type wavelength conversion layer and the second sintered body type wavelength conversion layer includes arranging the first sintered body type wavelength conversion layer and the second sintered body type wavelength conversion layer so as to allow the first sintered body type wavelength conversion layer to have at its circumferential end a site not in contact with a circumferential end of the second sintered body type wavelength conversion layer at a boundary where the first sintered body type wavelength conversion layer and the second sintered body type wavelength conversion layer adjoin each other.

In the method for manufacturing a phosphor wheel according to a thirteenth aspect in addition to the twelfth aspect, the step of arranging the first sintered body type wavelength conversion layer and the second sintered body type wavelength conversion layer may include:
disposing a guide pin for alignment adjacent to the site not in contact; and
relatively moving along the guide pin the base plate and the first and second sintered body type wavelength conversion layers in a direction perpendicular to a surface of the base plate, to arrange the first sintered body type wavelength conversion layer and the second sintered body type wavelength conversion layer at sites of the base plate to which the adhesive layer is applied.

Embodiments will now be described in detail with appropriate reference to the drawings. Note, however, that more detailed explanations than necessary may be omitted. For example, detailed explanations of already well-known matters and duplicate explanations for substantially the same configurations may be omitted. This is to avoid unnecessary redundancy in the following description and to facilitate understanding of those skilled in the art. In the drawings, substantially the same members are designated by the same reference numerals.

The accompanying drawings and the following description are provided in order that those skilled in the art fully understand the present disclosure, but are not intended to limit the subject matter defined in the appended claims.

### First Embodiment

### 1-1 Configuration of Phosphor Wheel

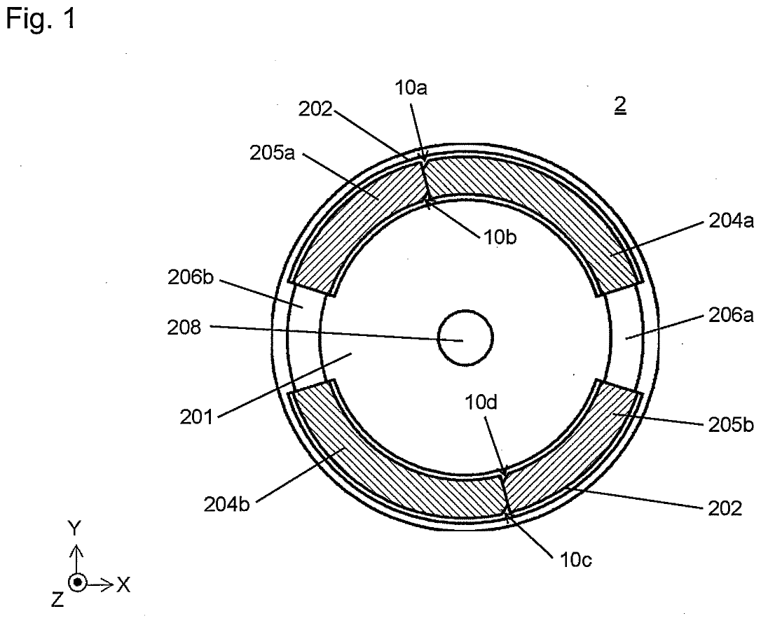

A configuration of a phosphor wheel 2 according to a first embodiment will be described in detail below. FIG. 1 is a schematic plan view showing a planar configuration of the phosphor wheel 2 according to the first embodiment. As shown in FIG. 1, the phosphor wheel 2 according to the first embodiment includes: a rotatable base plate 201; a plurality of wavelength conversion layers including first sintered body type wavelength conversion layers 204a and 204b and second sintered body type wavelength conversion layers 205a and 205b; and an adhesive layer 202 disposed between the base plate 201 and the first and second sintered body type wavelength conversion layers 204a, 204b, 205a, and 205b. The first sintered body type wavelength conversion layers 204a and 204b are made of a sintered body of first wavelength conversion particles that wavelength-convert excitation light into light with a first wavelength. The second sintered body type wavelength conversion layers 205a and 205b are made of a sintered body of second wavelength conversion particles that wavelength-convert excitation light into light with a second wavelength. The first sintered body type wavelength conversion layers 204a and 204b and the second sintered body type wavelength conversion layers 205a and 205b are arranged circumferentially adjoining each other, respectively. The first sintered body type wavelength conversion layers 204a and 204b and the second sintered body type wavelength conversion layers 205a and 205b have, at their respective circumferential ends, portions not in contact with the other's circumferential ends. Due to having the first and second wavelength conversion layers 204a, 204b, 205a, and 205b adjoining each other, the phosphor wheel 2 has high conversion efficiency and heat resistance.

The members constituting the phosphor wheel 2 will be described below.

<Base plate>

The base plate 201 may be, for example, an aluminum base plate having excellent heat dissipation properties. The base plate 201 is not limited to aluminum, but may be made of other metals. Alternatively, the base plate may be a transmitting base plate such as glass or sapphire. A reflective area may be disposed on the transmitting base plate such as glass or sapphire. The base plate 201 has a motor mounting hole 208 for mounting a motor for rotating the base plate 201. The motor may be attached to the base plate using a means other than the motor mounting hole 208.

### <Wavelength Conversion Layer>

The wavelength conversion layer includes the first sintered body type wavelength conversion layer 204a and 204b and the second sintered body type wavelength conversion layers 205a and 205b. These first and second sintered body type wavelength conversion layers 204a, 204b, 205a, and 205b are arranged on the same circumference around the center of rotation of the base plate 201. Openings 206a and 206b may be arranged on the same circumference. The number of the openings may be one or more. Alternatively, a reflective area may be disposed instead of the opening. The first sintered body type wavelength conversion layers 204a and 204b and the second sintered body type wavelength conversion layers 205a and 205b are adjoining each other, respectively, on the same circumference. At the other ends, they may be adjoining with the openings 206a and 206b in between.

The first and second sintered body type wavelength conversion layers 204a, 204b, 205a, and 205b each have a substantially annular shape with a certain thickness and each include: a front surface and a back surface that face each other and that are parallel to the surface of the base plate 201; an outer peripheral surface and an inner peripheral surface that connect the front surface and the back surface and that extend perpendicular to the radial direction; and two radially extending end surfaces that connect the front surface and the back surface and that are perpendicular to the front and back surfaces. Except the sites not in contact, one end surface of the first sintered body type wavelength conversion layers 204a and 204b is in contact with one end of the second sintered body type wavelength conversion layers 205a and 205b.

Note that when the first sintered body type wavelength conversion layers 204a, 204b and the second sintered body type wavelength conversion layers 205a and 205b are overlapped, this may cause problems such as no adhesive layer being disposed under one sintered body type wavelength conversion layer. Therefore, they may be adjoining each other with a small gap in between.

<First and Second Sintered Body type Wavelength Conversion Layers>

The first sintered body type wavelength conversion layers 204a and 204b are made of the sintered body of the first wavelength conversion particles that wavelength-convert excitation light into light with the first wavelength.

### <First Wavelength Conversion Particle>

The first wavelength conversion particle is a so-called phosphor particle and may be, for example, a particle having a garnet structure. The chemical formula of the garnet structure may be, for example, Y₃Al₅O₁₂ that wavelength-converts blue excitation light into yellow fluorescent light, or Lu₃Al₅O₁₂ that wavelength-converts blue excitation light into green fluorescent light. Alternatively, it may be a mixture thereof (Y, Lu)₃Al₅O₁₂. The activator may be, for example, Ce or Gd. The particle may be one that converts blue excitation light into fluorescent light other than yellow or green described above.

The second sintered body type wavelength conversion layers 205a and 205b are made of the sintered body of the second wavelength conversion particles that wavelength-convert excitation light into light with the second wavelength.

### <Second Wavelength Conversion Particle>

The second wavelength conversion particle is a so-called phosphor particle and may be, for example, a particle having a garnet structure, similar to the first wavelength conversion particle. The chemical formula of the garnet structure may be, for example, Y₃Al₅O₁₂ that wavelength-converts blue excitation light into yellow fluorescent light, or Lu₃Al₅O₁₂ that wavelength-converts blue excitation light into green fluorescent light. Alternatively, it may be a mixture thereof (Y, Lu)₃Al₅O₁₂. The activator may be, for example, Ce or Gd. The particle may be one that converts blue excitation light into fluorescent light other than yellow or green described above.

By changing the structure, composition, etc., the first wavelength and the second wavelength to be wavelength-converted by the first and second wavelength conversion particles can variously be changed.

As shown in FIG. 1, the phosphor wheel 2 according to the first embodiment is characterized in that the first sintered body type wavelength conversion layers 204a and 204b and the second sintered body type wavelength conversion layers 205a and 205b are arranged such that at least one end and one end of their respective layers are not in contact with each other at their adjoining boundaries. As used herein, “one end and one end are not in contact with each other” means that a site not in contact is present in at least a part of the respective ends near the boundaries. The “site not in contact” may be notches 10a, 10b, 10c, and 10d. Alternatively, the “site not in contact” may be a chamfered portion, for example, a cutout portion such as C-cut or slant cut. Chamfering may include not only straight lines but also curved lines. The shape of the end may be not only convex but also concave, e.g., rectangular or other polygonal shape, a circular shape, or an elliptical shape. These shapes of the end may be such that a guide pin can be set in a gap defined by the two ends adjoining at the boundary. The guide pin is used for alignment when attaching the first sintered body type wavelength conversion layers 204a and 204b and the second sintered body type wavelength conversion layers 205a and 205b to the base plate.

In the phosphor wheel 2 of the first embodiment, as shown in FIG. 1, the first sintered body type wavelength conversion layers 204a and 204b have the notches 10a and 10c, respectively, at the boundary ends adjoining the second sintered body type wavelength conversion layers 205a and 205b, while the second sintered body type wavelength conversion layers 205a and 205b have the notches 10b and 10d, respectively, at the boundary ends adjoining the first sintered body type wavelength conversion layers 204a and 204b. The notches 10a and 10c are disposed on the outer peripheral side of the ends the first sintered body type wavelength conversion layers 204a and 204b, while the notches 10b and 10d are disposed on the inner peripheral side of the ends of the second sintered body type wavelength conversion layers 205a and 205b. On the other hand, in the phosphor wheel 2 of the first embodiment, no notch is disposed on the inner peripheral side of the first sintered body type wavelength conversion layers 204a and 204b and on the outer peripheral side of the second sintered body type wavelength conversion layers 205a and 205b.

That is, the end surfaces at the ends of the first sintered body type wavelength conversion layers 204a and 204b facing the second sintered body type wavelength conversion layers 205a and 205b extend to the inner peripheral direction from the site in contact on the inner peripheral side with the end surfaces at the ends of the second sintered body type wavelength conversion layers 205a and 205b facing the first sintered body type wavelength conversion layers 204a and 204b, whereas the end surfaces at the ends of the second sintered body type wavelength conversion layers 205a and 205b facing the first sintered body type wavelength conversion layers 204a and 204b extend to the outer peripheral direction from the site in contact on the outer peripheral side with end surfaces at the ends of the first sintered body type wavelength conversion layers 204a and 204b facing the second sintered body type wavelength conversion layers 205a and 205b. In other words, the notches 10a and 10c confront the end surfaces at the ends of the second sintered body type wavelength conversion layers 205a and 205b facing the first sintered body type wavelength conversion layers 204a and 204b, whereas the notches 10b and 10d confront the end surfaces at the ends of the first sintered body type wavelength conversion layers 204a and 204b facing the second sintered body type wavelength conversion layers 205a and 205b. The end surfaces at the adjoining boundaries of the first and second sintered body type wavelength conversion layers 204a, 204b, 205a and 205b are substantially in contact with each other except the notches 10a, 10b, 10c, and 10d and the portions (sites not in contact) facing the notches 10a, 10b, 10c, and 10d.

Although the details will be described later, within the notches 10a, 10b, 10c, and 10d, guide pins are arranged for use in alignment of the first and second sintered body type wavelength conversion layers 204a, 204b, 205a, and 205b during the process of manufacturing the phosphor wheel 2. That is, at the boundaries where the first and second sintered body type wavelength conversion layers 204a, 204b, 205a, and 205b adjoin each other, the guide pins are arranged on the outer peripheral side at the ends of the first sintered body type wavelength conversion layers 204a and 204b and on the inner peripheral side at the ends of the second sintered body type wavelength conversion layers 205a and 205b. Since the notches 10a, 10b, 10c, and 10d are not in contact with the end surfaces of the confronting sintered body type wavelength conversion layers, the adhesive layer 202 is exposed from those sites.

Two ends near the boundaries need only have a site not in contact with each other on at least one of the inner peripheral side and the outer peripheral side. The first sintered body type wavelength conversion layers 204a and 204b and the second sintered body type wavelength conversion layers 205a and 205b may have rectilinear boundaries on the opposite side to the side where they adjoin each other.

According to the above configuration, when the first sintered body type wavelength conversion layers 204a and 204b and the second sintered body type wavelength conversion layers 205a and 205b are attached to the base plate adjoining each other, the guide pins can be arranged also at the boundaries therebetween. This ensures secure alignment of the first sintered body type wavelength conversion layers 204a and 204b and the second sintered body type wavelength conversion layers 205a and 205b. Thus, a phosphor wheel superior in conversion efficiency and heat resistance can be obtained.

### <Opening>

A plurality of openings may be disposed. In the case of disposing the openings 206a and 206b, excitation light passes through the openings 206a and 206b and therefore blue light is used as excitation light.

### <Method for Manufacturing Phosphor Wheel>

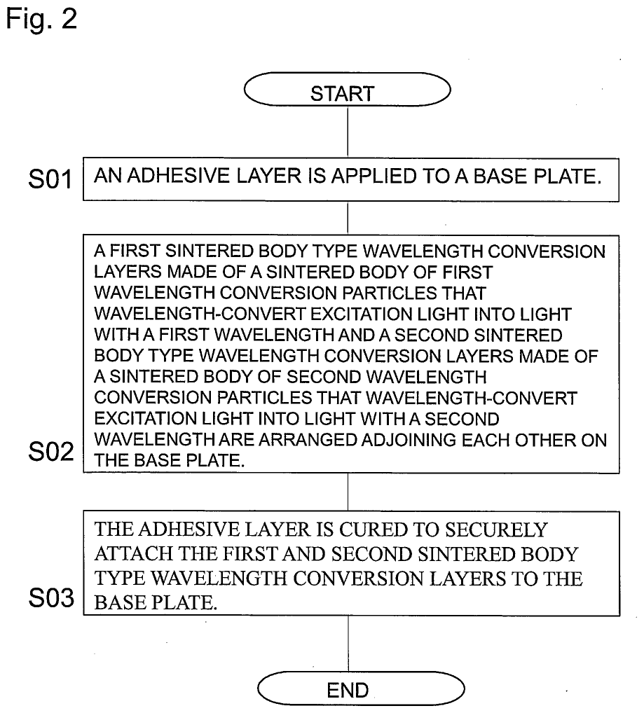

FIG. 2 is a flowchart showing a method for manufacturing a phosphor wheel according to the first embodiment. The method for manufacturing a phosphor wheel according to the first embodiment includes steps which follow.
(1) An adhesive layer is applied to a base plate (S01). The adhesive layer may be, for example, a mixed layer of a heat-resistant resin such as silicone or silsesquioxane filled with highly reflective particles. In this case, it also functions as a reflective layer. The adhesive layer may be a mixed layer of a heat-resistant resin such as silicone or silsesquioxane filled with highly thermal conductive particles. In this case, it also functions as a thermal conductive layer. In this case, an effect is achieved that the temperature rise of the phosphor layer is suppressed. Both the highly reflective particles and the highly thermal conductive particles may be mixed. The adhesive layer may be a heat-resistant resin such as silicone or silsesquioxane not filled with the particles.
(2) On top of the base plate, a first sintered body type wavelength conversion layers made of a sintered body of first wavelength conversion particles that wavelength-convert excitation light into light with a first wavelength and a second sintered body type wavelength conversion layers made of a sintered body of second wavelength conversion particles that wavelength-convert excitation light into light with a second wavelength are arranged adjoining each other (S02). The arrangement of the first sintered body type wavelength conversion layers and the second sintered body type wavelength conversion layers will be described later.
(3) The adhesive layer is cured to securely attach the first and second sintered body type wavelength conversion layers to the base plate (S03).

Through the above steps, the phosphor wheel according to the first embodiment is obtained.

<Step of Arranging First Sintered Body Type Wavelength Conversion Layer and Second Sintered Body Type Wavelength Conversion Layer on Base plate>

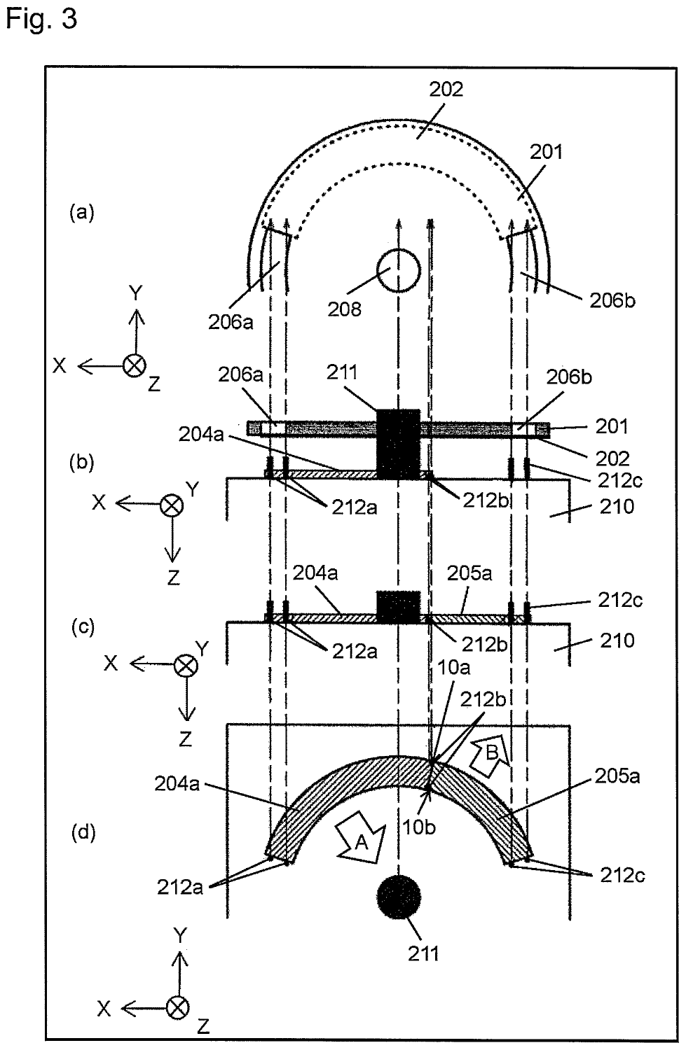

FIG. 3 shows, in the flowchart of the method for manufacturing a phosphor wheel of FIG. 2: (a) a planar see-through view showing a base plate having an adhesive layer disposed thereon and seen from the back surface of the base plate; (b) a front view showing the state where first sintered body type wavelength conversion layers are aligned on an attachment base in order to attach them onto the base plate of (a); (c) a front view showing the state where second sintered body type wavelength conversion layers are aligned adjoining the first sintered body type wavelength conversion layers; and (d) a schematic plan view showing the first and second sintered body type wavelength conversion layers aligned on the attachment base of (c) and arranged adjoining each other. Although description will be given for the first and second sintered body type wavelength conversion layers 204a and 205a, the same applies to the first and second sintered body type wavelength conversion layers 204b and 205b.

At the step of arranging the first sintered body type wavelength conversion layer 204a and the second sintered body type wavelength conversion layer 205a, guide pins 211, 212a, 212b, and 212c are used for alignment of the first sintered body type wavelength conversion layer 204a and the second sintered body type wavelength conversion layer 205a onto the base plate 201. The base plate 201 is retained apart from an attachment base 210 by the guide pin 211 extending through the motor mounting hole 208. At this time, the base plate 201 is disposed such that the adhesive layer 202 confronts the attachment base 210.

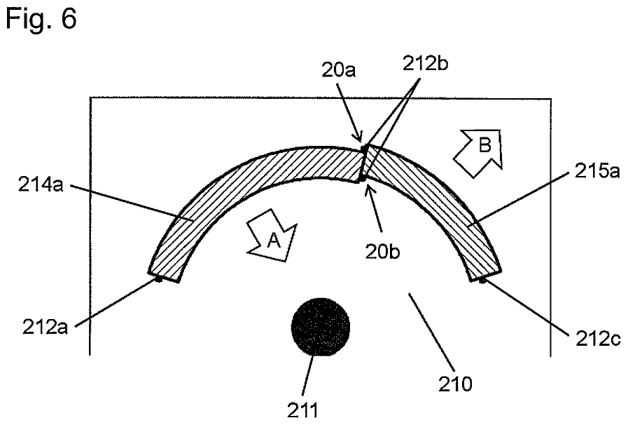

On the other hand, the first sintered body type wavelength conversion layer 204a and the second sintered body type wavelength conversion layer 205a are aligned on the attachment base 210. The guide pin 212a is disposed so as to extend through the opening 206a of the base plate 201 at the tip of the left end of the first sintered body type wavelength conversion layer 204a. The guide pin 212c is disposed so as to extend through the opening 206b of the base plate 201 at the tip of the right end of the second sintered body type wavelength conversion layer 205a. Although in FIG. 3 the case of using the two guide pins 212a and 212c is shown, this is not limitative. For example, a single guide pin may be used as shown in FIG. 6 described later, or more than two guide pins may be used. Two guide pins 212b are arranged at the boundary between the first sintered body type wavelength conversion layer 204a and the second sintered body type wavelength conversion layer 205a. As shown in FIG. 3(d), these guide pins are arranged in the notches 10a and 10b at the boundary between the first sintered body type wavelength conversion layer 204a and the second sintered body type wavelength conversion layer 205a. As shown in FIGS. 3(b) and 3(c), the guide pin 212b may have a height lower, for example, by several tens of μm, than that of the first sintered body type wavelength conversion layer 204a and the second sintered body type wavelength conversion layer 205a.

The first and second sintered body type wavelength conversion layers 204a and 205a are manufactured with dimensions having a certain tolerance with respect to the design values. In the arrangement of the first and second sintered body type wavelength conversion layers 204a and 205a, if the first and second sintered body type wavelength conversion layers 204a and 205a are manufactured with dimensions greater than the design values, the first and second sintered body type wavelength conversion layers 204a and 205a overlap each other. On the other hand, if the first and second sintered body type wavelength conversion layers 204a and 205a are manufactured with dimensions less than the design values, a gap will result between the first and second sintered body type wavelength conversion layers 204a and 205a.

Therefore, in the phosphor wheel 2 of the first embodiment, the first sintered body type wavelength conversion layer 204a is formed with dimensions not greater than the design values, whereas the second sintered body type wavelength conversion layer 205a is manufactured with dimensions not less than the design values. Furthermore, since the notch 10a lies on the outer peripheral side of the first sintered body type wavelength conversion layer 204a (FIG. 1), the guide pin 212b arranged in the notch 10a lies on the outer peripheral side of the first sintered body type wavelength conversion layer 204a but does not lie on the outer peripheral side of the second sintered body type wavelength conversion layer 205a. Similarly, since the notch 10b lies on the inner peripheral side of the second sintered body type wavelength conversion layer 205a (FIG. 1), the guide pin 212b arranged in the notch 10b lies on the inner peripheral side of the second sintered body type wavelength conversion layer 205a but does not lie on the inner peripheral side of the first sintered body type wavelength conversion layer 204a.

Since the guide pin 212b does not lie on the inner peripheral side of the first sintered body type wavelength conversion layer 204a, it is possible to move and position the first sintered body type wavelength conversion layer 204a manufactured with dimensions not greater than the design values toward the inner peripheral side (the direction indicated by an arrow A of FIG. 3) depending on the difference from the design values. Conversely, since the guide pin 212b does not lie on the outer peripheral side of the second sintered body type wavelength conversion layer 205a, it is possible to move and position the second sintered body type wavelength conversion layer 205a manufactured with dimensions not less than the design values toward the outer peripheral side (the direction indicated by an arrow B of FIG. 3) depending on the difference from the design values. Accordingly, the first sintered body type wavelength conversion layer 204a is guided and aligned by the two guide pins 212a and the guide pin 212b arranged on the inner peripheral side, whereas the second sintered body type wavelength conversion layer 205a is guided and aligned by the two guide pins 212c and the guide pin 212b arranged on the outer peripheral side. This enables the first and second sintered body type wavelength conversion layers 204a and 205a manufactured with dimensions having a certain tolerance to be aligned without gaps using the guide pins 212a, 212b, and 212c.

The step of arranging the first sintered body type wavelength conversion layer 204a and the second sintered body type wavelength conversion layer 205a on the base plate 201 is performed by relatively moving in Z-direction the base plate 201 on which the adhesive layer 202 is disposed (FIG. 3(a)) and the first sintered body type wavelength conversion layer 204a and the second sintered body type wavelength conversion layer 205a that are aligned on the attachment base 210. Specifically, the base plate 201 (FIG. 3(a)) having the adhesive layer 202 disposed thereon is moved along the guide pin 211 toward the attachment base 210 so that the first sintered body type wavelength conversion layer 204a and the second sintered body type wavelength conversion layer 205a can be attached to the adhesive layer 202 on top of the base plate 201.

The guide pin 212a at the left end of the first sintered body type wavelength conversion layer 204a is disposed so as to extend through the opening 206a of the base plate 201, while the guide pin 212c at the right end of the second sintered body type wavelength conversion layer 205a is disposed so as to extend through the opening 206b of the base plate 201. They are arranged so as to sandwich the site where the second sintered body type wavelength conversion layer is disposed. The guide pin 212b at the boundary between the first sintered body type wavelength conversion layer 204a and the second sintered body type wavelength conversion layer 205a has a height lower, for example, by several tens of μm, than that of the first and second sintered body type wavelength conversion layers 204a and 205a. For this reason, even when relatively moving the base plate 201 and the first and second sintered body type wavelength conversion layers 204a and 205a in Z-direction, the guide pin 212b is prevented from coming into contact with the base plate 201. This ensures secure alignment of the first sintered body type wavelength conversion layer 204a and the second sintered body type wavelength conversion layer 205a that adjoin each other. The base plate 201 may have a hole at a position corresponding to the guide pin 212b. This allows the height of the guide pin 212b to be higher than that of the first and second sintered body type wavelength conversion layers 204a and 205a.

Thus, according to this method of manufacturing a phosphor wheel, it is possible to form a plurality of sintered body type wavelength conversion layers that adjoin each other. This achieves high conversion efficiency and heat resistance.

### Second Embodiment

### 1-2 Configuration of Phosphor Wheel

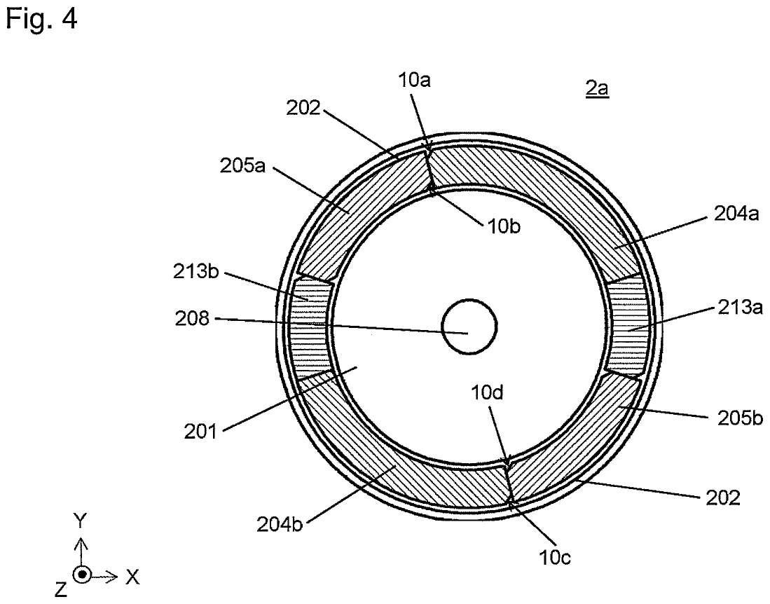

A configuration of a phosphor wheel 2a according to a second embodiment will be described in detail hereinbelow. FIG. 4 is a schematic plan view showing a planar configuration of the phosphor wheel 2a according to the second embodiment. In the following description, new elements of the phosphor wheel 2a according to the second embodiment as compared with the phosphor wheel 2 according to the first embodiment will be described, and the constituent elements described in FIG. 1 will not again be described.

As compared with the phosphor wheel 2 according to the first embodiment, as shown in FIG. 4, the phosphor wheel 2a according to the second embodiment differs therefrom in that it includes reflective areas 213a and 213b instead of the openings 206a and 206b. The reflective areas 213a and 213b reflect excitation light as it is.

Although the reflective areas 213a and 213b are disposed at substantially the same positions as the openings 206a and 206b of the phosphor wheel 2 according to the first embodiment, this is not limitative. The number of the reflective areas 213a and 213b is not limited to two, but may be one, or more than two.

In the case of disposing the reflective areas instead of the openings 2 in this manner, all light can be obtained as reflected light. Thus, there is no need to consider an optical circuit for photosynthesis of excitation light passing through the openings and whose wavelength has been changed and reflected light.

### Third Embodiment

### 1-3 Configuration of Phosphor Wheel

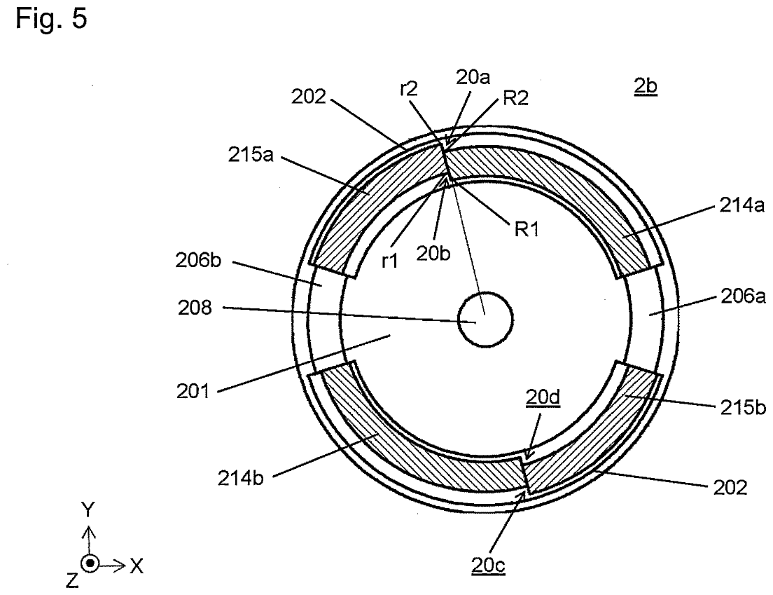

A configuration of a phosphor wheel 2b according to a third embodiment will be described in detail hereinbelow. FIG. 5 is a schematic plan view showing a planar configuration of the phosphor wheel 2b according to the third embodiment. In the following description, new elements of the phosphor wheel 2b according to the third embodiment as compared with the phosphor wheel 2 according to the first embodiment will be described, and explanations of the constituent elements described in FIG. 1 will be omitted.

As compared with the phosphor wheel 2 according to the first embodiment, as shown in FIG. 5, the phosphor wheel 2b according to the third embodiment differs therefrom in that at the boundary between first sintered body type wavelength conversion layers 214a and 214b and second sintered body type wavelength conversion layers 215a and 215b, it includes stepped portions 20a, 20b, 20c, and 20d by imparting different inner radii R1 and r1 and different outer radii R2 and r2 to the respective layers, in place of the notches. For example, in the example shown in FIG. 5, R1<r1 and R2<r2 are established.

The first and second sintered body type wavelength conversion layers 214a, 214b, 215a, and 215b each have a substantially annular shape with a certain thickness and each include: a front surface and a back surface that face each other and that are parallel to the surface of the base plate 201; an outer peripheral surface and an inner peripheral surface that connect the front surface and the back surface and that extend perpendicular to the radial direction; and two radially extending end surfaces that connect the front surface and the back surface and that are perpendicular to the front and back surfaces. Except the stepped portions, one end surface of the first sintered body type wavelength conversion layers 214a and 214b is in contact with one end of the second sintered body type wavelength conversion layers 215a and 215b.

In the phosphor wheel 2b, as shown in FIG. 5, at the boundary where the first and second sintered body type wavelength conversion layers 214a, 214b, 215a, and 215b adjoin each other, the inner radius R1 of the first sintered body type wavelength conversion layers 214a and 214b is less than the inner radius r1 of the second sintered body type wavelength conversion layers 215a and 215b, and hence the first sintered body type wavelength conversion layers 214a and 214b have, on the inner peripheral side of the ends, sites not in contact with the second sintered body type wavelength conversion layers 215a and 215b, whereas the outer radius r2 of the second sintered body type wavelength conversion layers 215a and 215b is greater than the outer radius R2 of the first sintered body type wavelength conversion layers 214a and 214b, and hence the second sintered body type wavelength conversion layers 215a and 215b have, on the outer peripheral side of the ends, sites not in contact with the first sintered body type wavelength conversion layers 214a and 214b. The end surfaces at the ends of the first sintered body type wavelength conversion layers 214a and 214b facing the second sintered body type wavelength conversion layers 215a and 215b extend toward the inner peripheral side from sites in contact on the inner peripheral side with the end surfaces at the ends of the second sintered body type wavelength conversion layers 215a and 215b facing the first sintered body type wavelength conversion layers 214a and 214b, whereas the end surfaces at the ends of the second sintered body type wavelength conversion layers 215a and 215b facing the first sintered body type wavelength conversion layers 214a and 214b extend toward the outer peripheral side from sites in contact on the outer peripheral side with the end surfaces at the ends of the first sintered body type wavelength conversion layers 214a and 214b facing the second sintered body type wavelength conversion layers 215a and 215b. The end surfaces at the boundaries where the first and second sintered body type wavelength conversion layers 214a, 214b, 215a, and 215b adjoin each other are substantially in contact with each other except the extending portions (sites not in contact). The stepped portions 20a and 20c are formed by the outer peripheral surfaces of the first sintered body type wavelength conversion layers 214a and 214b and portions extending toward the outer peripheral side of the end surfaces of the second sintered body type wavelength conversion layers 215a and 215b facing the first sintered body type wavelength conversion layers 214a and 214b, while the stepped portions 20b and 20d are formed by the inner peripheral surfaces of the second sintered body type wavelength conversion layers 215a and 215b and portions extending toward the inner peripheral side of the end surfaces of the first sintered body type wavelength conversion layers 214a and 214b facing the second sintered body type wavelength conversion layers 215a and 215b.

In FIG. 5, the inner radii R1 and r1 and the outer radii R2 and r2 of the first sintered body type wavelength conversion layers 214a and 214b and the second sintered body type wavelength conversion layers 215a and 215b are all different, but this is not limitative. For example, in the first sintered body type wavelength conversion layers 214a and 214b and the second sintered body type wavelength conversion layers 215a and 215b, at least one of the inner radii R1 and r1 and outer radii R2 and r2 from the center of rotation of the base plate may differ from each other.

The first sintered body type wavelength conversion layers 214a and 214b and the second sintered body type wavelength conversion layers 215a and 215b may each have the same width in the radial direction from the center of rotation of the base plate 201 at the boundaries where they adjoin each other. Alternatively, they may have widths different from each other. For example, in the example shown in FIG. 5, the radial width (r2-r1) of the second sintered body type wavelength conversion layers 215a and 215b is substantially the same as the radial width (R2-R1) of the first sintered body type wavelength conversion layers 214a and 214b.

By satisfying any of the above conditions, at least one pair of the radial positions (r1, r2, R1, and R2) of the second sintered body type wavelength conversion layers 215a and 215b and the first sintered body type wavelength conversion layers 214a and 214b can differ. This enables the guide pins to be arranged at the stepped portions 20a, 20b, 20c, and 20d between the first sintered body type wavelength conversion layers and the second sintered body type wavelength conversion layers by radially shifting from the sites where the second sintered body type wavelength conversion layers are disposed at the time of manufacturing a phosphor wheel. Thus, secure alignment can be performed at the time of adhering the first and second sintered body type wavelength conversion layers 214a, 214b, 215a, and 215b to the base plate.

Thus, according to this phosphor wheel manufacturing method, a plurality of sintered body type wavelength conversion layers adjoining each other can be formed. This achieves high conversion efficiency and heat resistance.

<Step of Arranging First Sintered Body Type Wavelength Conversion Layers and Second Sintered Body Type Wavelength Conversion Layers on Base plate>

FIG. 6 is a schematic plan view showing the first and second sintered body type wavelength conversion layers 214a and 215a aligned on the attachment base 210 and arranged adjoining each other in the method for manufacturing a phosphor wheel according to the third embodiment. Although description will be given for the first and second sintered body type wavelength conversion layers 214a and 215a, the same applies to the first and second sintered body type wavelength conversion layers 214b and 215b.

Also in the phosphor wheel 2b of the third embodiment, the first sintered body type wavelength conversion layer 214a is manufactured with dimensions not greater than the design values, and the second sintered body type wavelength conversion layer 215a is manufactured with dimensions not less than the design values. Furthermore, since the stepped portion 20a lies on the outer peripheral side of the first sintered body type wavelength conversion layers 214a, the guide pin 212b disposed on the stepped portion 20a lies on the outer peripheral side of the first sintered body type wavelength conversion layer 214a, but does not lie on the outer peripheral side of the second sintered body type wavelength conversion layer 215a. Similarly, since the stepped portion 20b lies on the inner peripheral side of the second sintered body type wavelength conversion layers 215a, the guide pin 212b disposed at the stepped portion 20b lies on the inner peripheral side of the second sintered body type wavelength conversion layer 215a, but does not lie on the inner peripheral side of the first sintered body type wavelength conversion layer 214a.

Since the guide pin 212b does not lie on the inner peripheral side of the first sintered body type wavelength conversion layer 214a, the first sintered body type wavelength conversion layer 214a manufactured with dimensions not greater than the design values can be shifted and arranged to the inner peripheral side (direction indicated by the arrow A of FIG. 6) depending on the difference from the design values. Conversely, since the guide pin 212b does not lie on the outer peripheral side of the second sintered body type wavelength conversion layer 215a, the second sintered body type wavelength conversion layer 215a manufactured with dimensions not less than the design values can be shifted and arranged to the outer peripheral side (direction indicated by the arrow B of FIG. 6) depending on the difference from the design values. Hence, the first sintered body type wavelength conversion layer 214a is guided and aligned by the guide pin 212a and the guide pin 212b arranged on the inner peripheral side, whereas the second sintered body type wavelength conversion layer 215a is guided and aligned by the guide pin 212c and the guide pin 212b arranged on the outer peripheral side. This enables the first and second sintered body type wavelength conversion layers 214a and 215a manufactured with dimensions having a certain tolerance with respect to the design values to be aligned without gaps using the guide pins 212a, 212b, and 212c.

As compared with FIG. 3, FIG. 6 differs in that a single guide pin 212a and a single guide pin 212c are employed. In this manner, the number of each of the guide pins 212a and 212c may be one, or, three or more, but normally two or one guide pin is used.

Since the guide pin 212b can be arranged on the stepped portions 20a, 20b, 20c, and 20d disposed at the boundaries between the first sintered body type wavelength conversion layers 214a and 214b and the second sintered body type wavelength conversion layers 215a and 215b, the alignment can securely be carried out for the first sintered body type wavelength conversion layers 214a and 214b and the second sintered body type wavelength conversion layers 215a and 215b.

### Fourth Embodiment

### Configuration of Phosphor Wheel

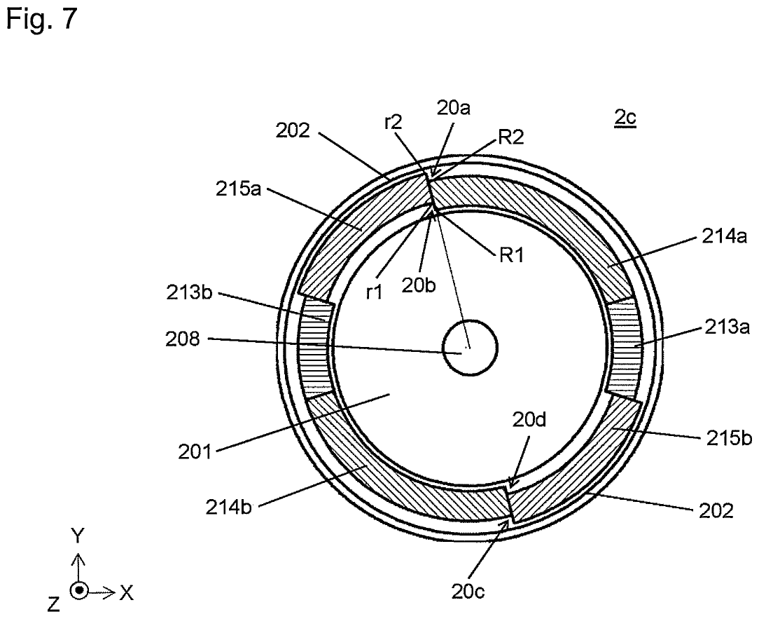

A configuration of a phosphor wheel 2c according to a fourth embodiment will be described in detail hereinbelow. FIG. 7 is a schematic plan view showing a planar configuration of the phosphor wheel 2c according to the fourth embodiment. In the following description, new elements of the phosphor wheel 2c according to the fourth embodiment as compared with the phosphor wheel 2b according to the third embodiment will be described, and the constituent elements described in FIG. 5 will not again be described.

As compared with the phosphor wheel 2b according to the third embodiment, as shown in FIG. 7, the phosphor wheel 2c according to the fourth embodiment differs therefrom in that it includes reflective areas 213a and 213b instead of the openings 206a and 206b. The reflective areas 213a and 213b reflect excitation light as it is.

Although the reflective areas 213a and 213b are disposed at substantially the same positions as the openings 206a and 206b of the phosphor wheel 2b according to the third embodiment, this is not limitative. The number of the reflective areas 213a and 213b is not limited to two, but may be one, or more than two.

In the case of disposing the reflective areas instead of the openings in this manner, all light can be obtained as reflected light. Thus, there is no need to consider the optical circuit for photosynthesis of excitation light passing through the openings and whose wavelength has been changed and reflected light.

### Fifth Embodiment

### 2-1 Light Source Device

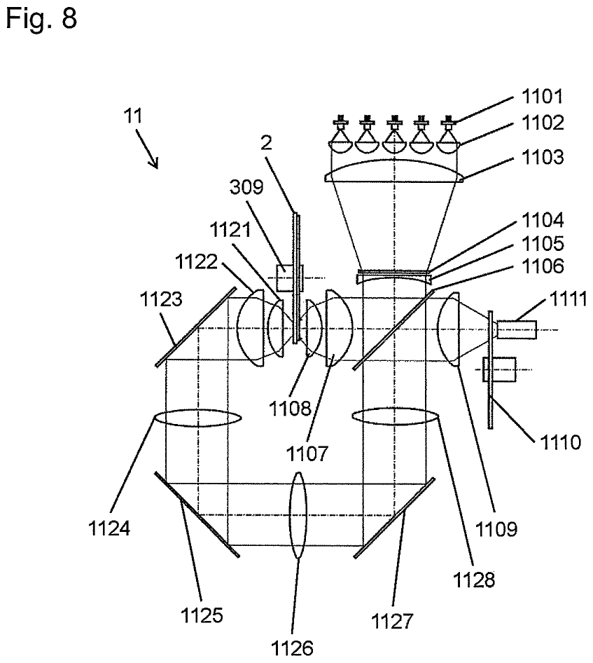

A configuration of a light source device 11 according to a fifth embodiment will be described in detail hereinbelow. FIG. 8 is a view showing a configuration of the light source device 11 according to the fifth embodiment. This light source device 11 uses the phosphor wheel 2 according to the first embodiment. Thus, description will be given using the phosphor wheel 2 according to the first embodiment.

Laser light having a blue wavelength range emitted from a plurality of laser light sources 1101 is collimated by a plurality of collimator lenses 1102 each arranged corresponding to each of the laser light sources 1101. The collimated blue light enters a succeeding convex lens 1103 to reduce its luminous flux width and then enters a diffuser plate 1104 which follows for diffusion to improve the uniformity of light. The blue light having improved light uniformity is incident on a succeeding concave lens 1105 and collimated into a parallel luminous flux.

The blue light collimated into a parallel luminous flux impinges on a color separation/combining mirror 1106 disposed at an inclination angle of approx. 45 degrees to the optical axis and changes 90 degrees the direction of travel of the light, to enter a succeeding convex lens 1107. The color separation/combining mirror 1106 has spectral characteristics that reflect light having a blue light wavelength range emitted from the laser light sources 1101 and that transmit light having a fluorescence wavelength range obtained by wavelength-converting in the phosphor wheel 2 described later the blue light that is excitation light emitted from the laser light sources 1101.

Although in this example, the color separation/combining mirror 1106 has the spectral characteristics focusing on the wavelength characteristics of the blue light from the laser light sources and the wavelength-converted fluorescence, the present invention is not limited thereto, and may have spectral characteristics focusing on, for example, polarization and wavelength. Specifically, the polarization direction of the laser light sources may be focused on so that the polarization direction of the blue light from the laser light sources is adjusted to the same direction. This may allow the color separation/combining mirror to have spectral characteristics focusing on polarization and wavelength, such as reflecting light of the blue wavelength range and polarization direction from the laser light sources and transmitting light of the wavelength range of the wavelength-converted fluorescence.

The blue light incident on the convex lens 1107 enters, in cooperation with a succeeding convex lens 1108, the wavelength conversion layers 204a, 204b, 205a, and 205b and the openings 206a and 206b on the same radius arranged on the succeeding phosphor wheel 2.

The phosphor wheel 2 includes a motor 309. Arrangement is such that around a rotation axis of the motor 309, the blue excitation light condensed by the convex lenses 1107 and 1108 enters a region of the same radius from the rotation center in which the wavelength conversion layers 204a, 204b, 205a, and 205b and the opening 206 are arranged.

First, the blue light condensed on the wavelength conversion layers 204a, 204b, 205a, and 205b of the phosphor wheel 2 by the convex lenses 1107 and 1108 is wavelength-converted into fluorescence and changes the direction of travel of the light by 180 degrees to reenter the convex lenses 1108 and 1107 in the mentioned order to be collimated into a parallel luminous flux. The fluorescence wavelength-converted by the phosphor wheel 2 has wavelength regions optimized to form, for example, white light in cooperation with the blue light emitted from the laser light sources 1101.

The fluorescence emitted from the convex lens 1107 and collimated into a parallel luminous flux reenters the color separation/combining mirror 1106. Since as described earlier, the color separation/combining mirror 1106 has the characteristic of transmitting light of a fluorescence wavelength range and is arranged at the angle of approx. 45 degrees to the optical axis, it transmits fluorescence intactly without changing the direction of travel of the fluorescence.

Next, the blue light from the laser light sources 1101 condensed onto the openings 206a and 206b of the phosphor wheel 2 passes through the phosphor wheel 2 and is collimated into a parallel luminous flux by succeeding convex lenses 1121 and 1122. Then, through a posteriorly positioned relay lens system including three mirrors 1123, 1125, and 1127 and three convex lenses 1124, 1126, and 1128, light is guided to the color separation/combining mirror 1106 so that the light collimated into a parallel luminous flux enters from 180 degrees opposite direction to the direction in which light from the laser light sources 1101 enters.

Although the relay optical system is configured here using three mirrors and three convex lenses, other configurations may be used as long as they have similar performance.

Since the color separation/combining mirror 1106 has the characteristic of reflecting blue light from the laser light sources 1101, the blue light incident on the color separation/combining mirror 1106 from the convex lens 1128 is reflected with its direction of travel changed by 90 degrees.

In this manner, the above configuration allows fluorescence and blue light combined together in a time-division manner by the color separation/combining mirror 1106 to enter a convex lens 1109 that is a succeeding optical system.

The time-divided fluorescence and blue light incident on the convex lens 1109 from the color separation/combining mirror 1106 are condensed by the convex lens 1109 in the vicinity of the entrance end of a rod integrator 1111 that will be described later. The light leaving the convex lens 1109 enters a color filter wheel 1110 before entering the rod integrator 1111. The color filter wheel 1110 is synchronized with the phosphor wheel 2 using a synchronizing circuit (not shown), and is composed of a plurality of filters having a spectral characteristic that transmits some or all of the wavelength ranges of blue light and fluorescent light depending on the characteristics of the optical system.

The color filter wheel 1110 has: a region that transmits yellow fluorescence from the phosphor wheel 2 with its unchanged fluorescence wavelength range; a region that transmits green fluorescence from the phosphor wheel 2 with its unchanged fluorescence wavelength range; a region that reflects light in the green wavelength range of the fluorescence and transmits light in the red wavelength range, and a region that transmits intactly light in the blue wavelength range passing through the openings 206a and 206b from the phosphor wheel 2. Since the phosphor wheel 2 and the color filter wheel 1110 rotate in synchronism, light of different wavelength range is condensed in a time series near the entrance end of the rod integrator 1111. Note that the configuration of the color filter wheel is not limited to the above configuration, and may be changed as appropriate depending on the specifications of the phosphor wheel, light source device, and projection-type video display device.

The light having a wavelength range different in a time division manner incident on the rod integrator 1111 is homogenized by the rod integrator and emitted from the exit end. Although in the explanation of FIG. 6, the color filter wheel 1110 is disposed near the entrance side of the rod integrator 1111, it may be disposed near the exit side thereof.

### <Effect>

The light source device 11 according to the fifth embodiment uses the phosphor wheel 2 according to the first embodiment and therefore can obtain excellent conversion efficiency and heat resistance. The phosphor wheel 2 according to the first embodiment may be replaced by the phosphor wheel 2b according to the third embodiment.

### 3-1 Projection Type Video Display Device

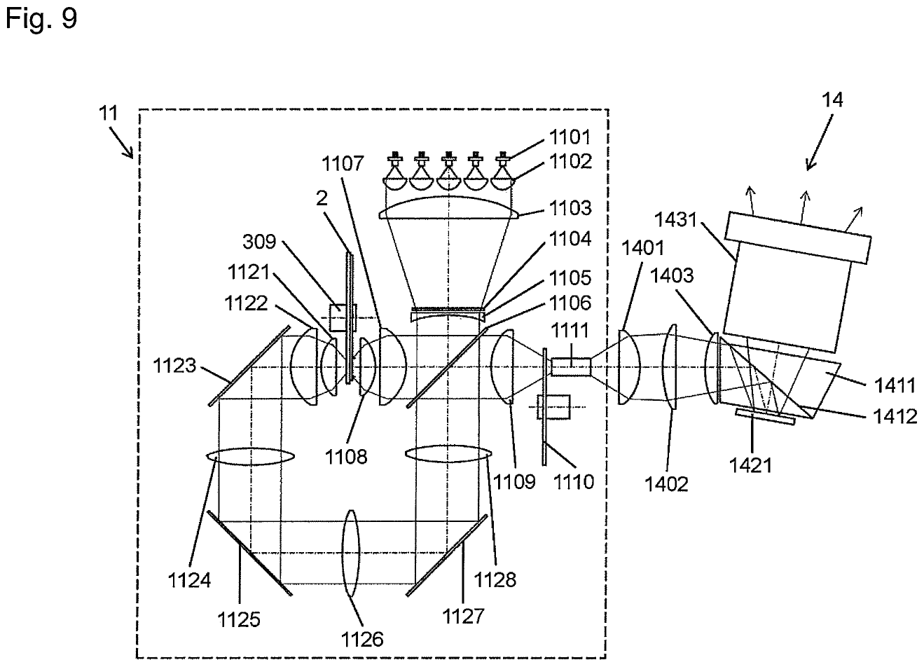

Hereinafter, description will be given of details of a projection type video display device 14 mounted with the light source device 11 according to the fifth embodiment. FIG. 9 is a view showing a configuration of the projection type video display device 14 employing the light source device 11 according to the fifth embodiment. Since the configuration of the light source device 11 using the phosphor wheel 2 according to the fifth embodiment has been described above, the description thereof will be omitted here, and the behavior of light after emission from the rod integrator 1111 will be described in detail.

The light leaving the rod integrator 1111 is mapped onto a DMD 1421 that will be described later, through a relay lens system including convex lenses 1401, 1402, and 1403.

The light passing through the convex lenses 1401, 1402, and 1403 and incident on a total reflection prism 1411 enters a minute gap 1412 of the total reflection prism 1411 at an angle equal to or greater than the total reflection angle and is reflected to change the direction of travel of light to enter the DMD 1421.

In synchronization with colored light emitted from the combination of the phosphor wheel 2 and the color filter wheel 1110, the DMD 1421 changes the direction of a micromirror to change the direction of travel of the light, for light emission, in response to a signal from a video circuit not shown. The light whose direction of travel has been changed by the DMD 1421 in response to a video signal enters the minute gap 1412 of the total reflection prism 1411 at an angle equal to or less than the total reflection angle to pass through as it is, and enters a projection lens 1431 to be projected onto a screen not shown.

### <Effect>

In the projection type video display device 14 using the light source device 11 according to the fifth embodiment, excellent conversion efficiency and heat resistance can be obtained by virtue of the use of the phosphor wheel 2 according to the first embodiment (or the phosphor wheel 2b according to the third embodiment).

### Sixth Embodiment

### 2-2 Light Source Device

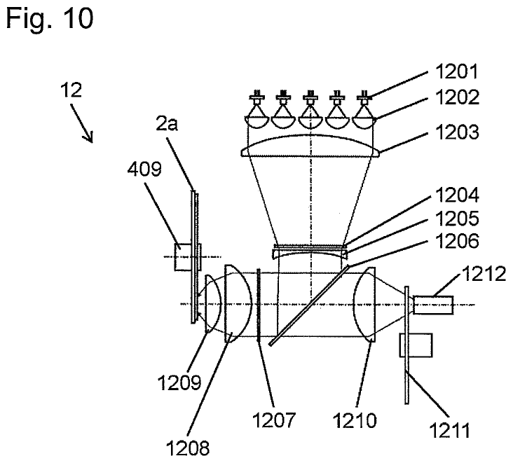

Hereinafter, details of a light source device 12 according to a sixth embodiment will be described. FIG. 10 is a diagram showing a configuration of the light source device 12 according to the sixth embodiment. This light source device 12 uses the phosphor wheel 2a according to the second embodiment. Thus, description will be given using the phosphor wheel 2a according to the second embodiment shown in FIG. 4.

Laser light in a blue wavelength range emitted from a plurality of laser light sources 1201 is collimated by a plurality of collimator lenses 1202 each arranged corresponding to each of the laser light sources 1201. The collimated blue light enters a succeeding convex lens 1203 to reduce its luminous flux width and then enters a succeeding diffuser plate 1204 which follows for diffusion to improve the uniformity of light. The blue light having light uniformity improved by the diffuser plate 1204 is incident on a succeeding concave lens 1205 and collimated into a parallel luminous flux.

Incidentally, the optical system up to the concave lens 1205 adjusts the polarization direction of the laser light so that the laser light becomes S-polarized light with respect to a polarization and color separation/combining mirror 1206 that will be described later when it is emitted from the concave lens 1205.

The blue light collimated into a parallel luminous flux by the concave lens 1205 impinges on the polarization and color separation/combining mirror 1206 disposed at an inclination angle of approx. 45 degrees to the optical axis and changes the direction of travel of the light by 90 degrees, to enter a succeeding λ/4 wavelength plate 1207. The polarization and color separation/combining mirror 1206 has spectral characteristics that reflect S-polarized light having a blue wavelength range emitted from the laser light sources 1201 and that transmit P-polarized light having a blue wavelength range emitted from the laser light sources 1201 and light having a fluorescence wavelength range obtained by wavelength-converting in the phosphor wheel 2a described later the blue light that is excitation light emitted from the laser light sources 1201.

The polarization direction of the blue light from the laser light sources 1201 incident on the λ/4 wavelength plate 1207 is rotated, changing it to circular polarization.

The light leaving the λ4 wavelength plate 1207 enters a convex lens 1208 and then, under cooperation with a succeeding convex lens 1209, enters the reflective regions 213a and 213b and the wavelength conversion layers 204a, 204b, 205a, and 205b disposed on the succeeding phosphor wheel 2a. A motor 409 is disposed on the phosphor wheel 2a and is arranged to allow, around its rotation axis, blue excitation light condensed by the convex lenses 1108 and 1109 to impinge on the reflective regions 213a and 213b and the wavelength conversion layers 204a, 204b, 205a, and 205b.

First, the blue light condensed on the wavelength conversion layers 204a, 204b, 205a, and 205b of the phosphor wheel 2a by the convex lenses 1208 and 1209 is converted into fluorescence and changes the direction of travel of the light by 180 degrees to reenter the convex lenses 1209 and 1208 in the mentioned order to be collimated into a parallel luminous flux. The fluorescence wavelength-converted by the phosphor wheel 2a has wavelength regions optimized to form, for example, white light in cooperation with the blue light emitted from the laser light sources 1201.

The fluorescence collimated into a parallel luminous flux by the convex lens 1208 and emitted therefrom passes through the λ/4 wavelength plate 1207 and reenters the polarization and color separation/combining mirror 1206 arranged at the angle of 45 degrees to the optical axis. Since as described earlier, the polarization and color separation/combining mirror 1206 has the characteristic of transmitting light having a fluorescence wavelength range, it transmits fluorescence intactly without changing the direction of the light, allowing the fluorescence to enter a succeeding convex lens 1210.

Next, the blue light from the laser light sources 1201 condensed onto the reflective regions 213a and 213b of the phosphor wheel 2a is reflected on the reflective regions 213a and 213b of the phosphor wheel 2a to change its direction of travel by 180 degrees, and enters the convex lenses 1209 and 1208 in the mentioned order, to be collimated into a parallel luminous flux.

The blue light collimated into a parallel luminous flux by the convex lenses 1209 and 1208 enters the succeeding λ/4 wavelength plate 1207 to rotate its direction of polarization to be converted into P-polarized light for emission.

The light of P-polarized light having blue wavelength range emitted from the λ/4 wavelength plate 1207 impinges on the polarization and color separation/combining mirror 1206 arranged at the angle of approx. 45 degrees to the optical axis. The polarization and color separation/combining mirror 1206 has characteristics that reflect the light of S-polarized light having a blue wavelength range emitted from the laser light sources 1201 and transmit the light of P-polarized light having a blue wavelength range emitted from the laser light sources 1201 and the light having a fluorescence wavelength range wavelength-converted by the phosphor wheel 2a. Therefore, the light of P-polarized light having a blue wavelength range emitted from the λ/4 wavelength plate 1207 passes through as it is without changing the direction of travel of the light, to enter the succeeding convex lens 1210.

The convex lens 1210 receives the fluorescence and the blue light in a time series depending on the rotation of the phosphor wheel 2a and condenses them onto the vicinity of the entrance end of a rod integrator 1212 that will be described later. The light condensed by the convex lens 1210 enters a color filter wheel 1211. The color filter wheel 1211 has a configuration similar to that of the color filter wheel 1110 employed in the light source device 11 that employs the phosphor wheel according to the first embodiment, and when the phosphor wheel 2a and the color filter wheel 1211 rotate in synchronism, light having a different light wavelength range is condensed in a time series in the vicinity of the entrance end of the rod integrator 1212.

The light having a wavelength range different in a time-division manner incident on the rod integrator 1212 is homogenized by the rod integrator 1212 and emitted from the exit end. Although in the explanation of FIG. 9, the color filter wheel 1211 is disposed near the entrance side of the rod integrator 1111, it may be disposed near the exit side thereof.

### <Effect>

The light source device 12 according to the sixth embodiment uses the phosphor wheel 2a according to the second embodiment and therefore can obtain excellent conversion efficiency and heat resistance. The phosphor wheel 2a according to the second embodiment may be replaced by the phosphor wheel 2c according to the fourth embodiment.

### 3-2 Projection Type Video Display Device

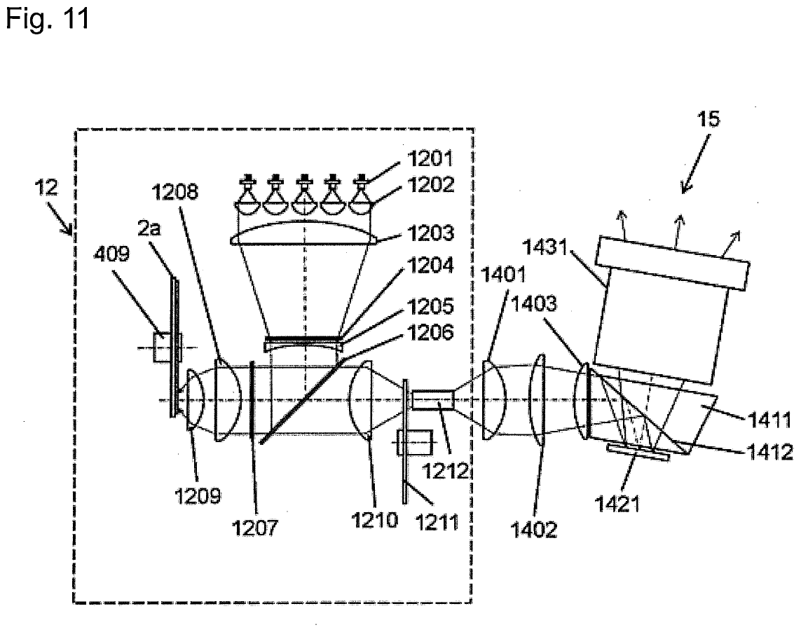

Hereinafter, description will be given of details of a projection type video display device 15 mounted with the light source device 12 according to the sixth embodiment. FIG. 11 is a view showing a configuration of the projection type video display device 15 mounted with the light source device 12 according to the sixth embodiment.

Since the configuration of the light source device 12 according to the sixth embodiment has been described above, the description thereof will be omitted here. The behavior of light after emission from the rod integrator 1212 is substantially the same as the behavior of light after emission from the rod integrator 1111 that has been described in FIG. 8, and hence the description thereof will be omitted here.

### <Effect>

The projection type video display device 15 using the light source device 12 according to the sixth embodiment employes the phosphor wheel 2a according to the second embodiment (or the phosphor wheel 2c according to the fourth embodiment) and therefore can obtain excellent conversion efficiency and heat resistance.

The present disclosure encompasses appropriate combination of any embodiments and/or examples, among the various embodiments and/or examples set forth hereinabove and can achieve the effects that the embodiments and/or examples have.

The phosphor wheel according to the present disclosure includes the first and second sintered body type wavelength conversion layers which adjoin each other. This ensures excellent conversion efficiency and heat resistance.

### EXPLANATION OF REFERENCES

2, 2a, 2b, 2c phosphor wheel
10a, 10b, 10c, 10d notch
20a, 20b, 20c, 20d stepped portion
201 base plate
202 adhesive layer
204a, 204b, 214a, 214b first sintered body type wavelength conversion layer
205a, 205b, 215a, 215b second sintered body type wavelength conversion layer
206a, 206b opening
208 motor mounting hole
210 attachment base
211 guide pin
212a, 212b, 212c guide pin
213a, 213b reflective area
11 light source
1101 laser light source
1102 collimator lens
1103 convex lens
1104 diffuser plate
1105 concave lens
1106 color separation/combining mirror
1107 convex lens
1108 convex lens
309 motor
1109 convex lens
1110 color filter wheel
1111 rod integrator
1121 convex lens
1122 convex lens
1123 mirror
1124 convex lens
1125 mirror
1126 convex lens
1127 mirror
1128 convex lens
12 light source
1201 laser light source
1202 collimator lens
1203 convex lens
1204 diffuser plate
1205 concave lens
1206 polarizing and color separation/combining mirror
1207 λ/4 wavelength plate
1208 convex lens
1209 convex lens
409 motor
1210 convex lens
1211 color filter wheel
1212 rod integrator
14 projection type video display device
1401 convex lens (relay lens)
1402 convex lens (relay lens)
1403 convex lens (relay lens)
1411 total reflection prism
1412 minute Gap
1421 DMD 1421
1431 projection lens
15 projection type video display device
R1, r1 inner diameter
R2, r2 outside diameter

1. A phosphor wheel comprising:
a rotatable base plate;
a plurality of wavelength conversion layers arranged on the base plate, the plurality of wavelength conversion layers including a first sintered body type wavelength conversion layer and a second sintered body type wavelength conversion layer which are arranged adjoining each other in a circumferential direction around a center of rotation of the base plate, the first sintered body type wavelength conversion layer having a sintered body of first wavelength conversion particles that wavelength-convert excitation light into light with a first wavelength, the second sintered body type wavelength conversion layer having a sintered body of second wavelength conversion particles that wavelength-convert the excitation light into light with a second wavelength different from the first wavelength; and
an adhesive layer disposed between the base plate and the plurality of wavelength conversion layers,
at a boundary where the first sintered body type wavelength conversion layer and the second sintered body type wavelength conversion layer adjoin each other, the first sintered body type wavelength conversion layer having at its end in the circumferential direction a site not in contact with an end of the second sintered body type wavelength conversion layer in the circumferential direction.

2. The phosphor wheel according to claim 1, wherein
the site not in contact is a notch disposed at the end of the first sintered body type wavelength conversion layer.

3. The phosphor wheel according to claim 1, wherein
the site not in contact is a cutout disposed on at least one of inner peripheral side and outer peripheral side at the end of the first sintered body type wavelength conversion layer.

4. The phosphor wheel according to claim 1, wherein
the first sintered body type wavelength conversion layer and the second sintered body type wavelength conversion layer have at their adjoining boundary mutually different inner radii and/or mutually different outer radii from the center of rotation of the base plate.

5. The phosphor wheel according to claim 1, wherein
the first sintered body type wavelength conversion layer and the second sintered body type wavelength conversion layer have at their adjoining boundary mutually different radial width around the center of rotation of the base plate.

6. The phosphor wheel according to claim 1, wherein
an end surface at the end of the first sintered body type wavelength conversion layer facing the second sintered body type wavelength conversion layer extends toward inner peripheral side from a site in contact on the inner peripheral side with an end surface at the end of the second sintered body type wavelength conversion layer facing the first sintered body type wavelength conversion layer, and wherein
an end surface at the end of the second sintered body type wavelength conversion layer extends toward outer peripheral side from a site in contact on the outer peripheral side with the end surface at the end of the first sintered body type wavelength conversion layer.

7. The phosphor wheel according to claim 1, wherein
the adhesive layer is exposed between the site not in contact of the first sintered body type wavelength conversion layer and the end of the second sintered body type wavelength conversion layer.

8. The phosphor wheel according to claim 1, wherein
the phosphor wheel has an opening disposed on a circumference on which the plurality of wavelength conversion layers are arranged around the center of rotation of the base plate.

9. The phosphor wheel according to claim 1, wherein
the phosphor wheel has a reflective area disposed on a circumference on which the plurality of wavelength conversion layers are arranged around the center of rotation of the base plate.

10. A light source device comprising the phosphor wheel according to claim 1.

11. A projection type video display device comprising the light source device according to claim 10.

12. A method for manufacturing a phosphor wheel, comprising:
applying an adhesive layer onto a base plate;
arranging a first sintered body type wavelength conversion layer and a second sintered body type wavelength conversion layer adjoining each other on the base plate, the first sintered body type wavelength conversion layer having a sintered body of first wavelength conversion particles that wavelength-convert excitation light into light with a first wavelength, the second sintered body type wavelength conversion layer having a sintered body of second wavelength conversion particles that wavelength-convert the excitation light into light with a second wavelength different from the first wavelength; and
curing the adhesive layer to securely attach the first sintered body type wavelength conversion layer and the second sintered body type wavelength conversion layer to the base plate, wherein
the step of arranging the first sintered body type wavelength conversion layer and the second sintered body type wavelength conversion layer includes arranging the first sintered body type wavelength conversion layer and the second sintered body type wavelength conversion layer so as to allow the first sintered body type wavelength conversion layer to have at its circumferential end a site not in contact with a circumferential end of the second sintered body type wavelength conversion layer at a boundary where the first sintered body type wavelength conversion layer and the second sintered body type wavelength conversion layer adjoin each other.

13. The method for manufacturing a phosphor wheel according to claim 12, wherein
the step of arranging the first sintered body type wavelength conversion layer and the second sintered body type wavelength conversion layer includes:
disposing a guide pin for alignment adjacent to the site not in contact; and
relatively moving along the guide pin the base plate and the first and second sintered body type wavelength conversion layers in a direction perpendicular to a surface of the base plate, to arrange the first sintered body type wavelength conversion layer and the second sintered body type wavelength conversion layer at sites of the base plate to which the adhesive layer is applied.
